(19) United States
(12) Patent Application Publication
(10) Pub. No.: US 2003/0063756 A1
(43) Pub. Date: Apr. 3, 2003

(54) Vehicle communication system

(75) Inventors: Steven L. Geerlings, Zeeland, MI (US); Thomas R. Olson, Holland, MI (US); William E. Troutman, Hamilton, MI (US)

Correspondence Address: FOLEY & LARDNER, 777 EAST WISCONSIN AVENUE, MILWAUKEE, WI, 53202, US

(73) Assignee: Johnson Controls Technology Company

(21) Appl. No.: 09/967,657

(22) Filed: Sep. 28, 2001

(51) Int. Cl. H04B 1/00

(52) U.S. Cl. 381/86

(57) ABSTRACT

A vehicle communication system provides for enhanced communication with passengers using in-vehicle entertainment systems. A microphone is activated by a driver or passenger, and sound is broadcast from the microphone to at least one loudspeaker. In addition, a broadcast of audio signals from an in-vehicle entertainment systems to headphones worn by a passenger is interrupted.

### BACKGROUND OF THE DISCLOSURE

In a competitive market where product differentiation is often a key to success, vehicle manufacturers have increasingly focused attention on automobile interiors. Today consumers may not only choose a vehicle make and model, but also may customize vehicles with a wide variety of options designed to make the driving experience more pleasant for both drivers and passengers. Innovations in technology and interior automobile design have increased passenger comfort and satisfaction.

One recent innovation, particularly in larger vehicles such as vans and sport utility vehicles, is the in-vehicle entertainment system. Such systems may include one or more electronic components such as televisions, stereos, CD players, video cassette players, DVD players, video game consoles, and computers. Stereo loudspeakers may be added to enhance the overall entertainment experience. During long trips, passengers may watch television or recorded videos, listen to music, or play video games. In-vehicle entertainment systems provide a variety of entertainment options, thus greatly enhancing the travel experience.

In-vehicle entertainment systems may also be provided with at least one set of headphones. The headphones may allow some passengers to enjoy features of the entertainment system without disturbing others in the passenger compartment. One difficulty that arises with the use of headphones involves communication between occupants. For instance, a driver may wish to notify passengers that the vehicle is approaching its destination. If some passengers are watching a movie while wearing headphones, it may be difficult or impossible for them to hear the driver's voice.

A prior system pertained to the use of an intercom system for use in light aircraft in conjunction with a stereo or cassette tape player. This system allows for partial muting of an audio broadcast, whereby the level or volume of music or other audio is significantly, but not totally, reduced whenever an intercom microphone or communications radio signal is present. One disadvantage of this method is that passengers may be unable to hear the driver due to excess noise in the passenger compartment. Similarly, since the entertainment audio signal is still present, albeit in partially muted form, it may be difficult for the listener to separate the message from the entertainment signal. The driver may thus be forced to shout so that passengers can hear the announcement. Yet a further disadvantage is that only passengers wearing headphones will be able to hear the message, since the sound would only be broadcast to the headphone speakers. Passengers not wearing headphones may be totally unaware that the driver has delivered a message.

Another difficulty with making announcements is that passengers listening to audio or enjoying other entertainment programs may be inconvenienced by the interruption, since they may be forced to rewind the program or otherwise return to the point of interruption of the program. A prior system concerns an entertainment and public address system suited for mass transit vehicles, including a tape recorder on which recorded information such as music can be played through loudspeakers. The system includes a public address circuit that included a switch which, when actuated, energizes a time delay network to rewind the tape recorder a preselected amount regardless of the length of time the public address system is in use. A disadvantage of this method is that the length of various announcements will vary, and the passenger may still be inconvenienced. For example, if a long announcement is broadcast, the program may not rewind to the point of interruption, and the passenger will have to rewind further. If a short announcement is made, the program may be rewound too far, and the passenger will be forced to listen to a portion of the entertainment broadcast again.

Thus, there is a need for a method of communicating with passengers who are using components of an in-vehicle entertainment system. There is a further need to provide a method of communicating with passengers who are wearing headphones. There is yet a further need to communicate with all passengers in the vehicle at the same time, regardless of whether they are using components of an in-vehicle entertainment system or wearing headphones. There is even further still a need to provide a method of interrupting an entertainment broadcast in a way that minimizes the inconvenience to the passenger enjoying the broadcast.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY OF EXEMPLARY EMBODIMENTS

One embodiment relates to a method of communicating with passengers in an automobile. The method includes activating a microphone and interrupting a broadcast by an in-vehicle entertainment system. The broadcast includes audio signals which are transmitted to headphones worn by at least one passenger. Finally, the method includes broadcasting sound from the microphone to at least one loudspeaker.

Another embodiment relates to a method for enabling communication between vehicle passengers. The method includes activating an intercom system and interrupting audio signals being broadcast from a vehicle entertainment system to at least one pair of headphones. The intercom system includes a microphone and at least one speaker configured for broadcasting sound from the microphone. The method also includes transmitting a message from the microphone to the at least one speaker.

Yet another embodiment relates to a system for enhancing communication with vehicle passengers. The system includes a microphone located in a forward section of a vehicle and at least one loudspeaker in communication with the microphone. Also included in the system is at least one pair of headphones in communication with an in-vehicle entertainment system, where the headphones are configured for receiving audio signals broadcast from the entertainment system. The system further includes means for overriding audio signals transmitted from the entertainment system to the headphones and simultaneously broadcasting audio signals from the microphone to the loudspeaker.

Yet still another embodiment relates to a communications system for use in conjunction with in-vehicle entertainment components. The system includes an in-vehicle entertainment system that includes at least one loudspeaker, at least one electronic component capable of generating audio signals, and at least one pair of headphones configured for receiving the audio signals. The system also includes means for interrupting the audio signals and broadcasting a message to the at least one loudspeaker.

### BRIEF DESCRIPTION OF THE DRAWINGS

The invention will become more fully understood from the following detailed description, taken in conjunction with the accompanying figures, wherein like reference numerals refer to like elements, in which:

FIG. 1 is a perspective view of a vehicle including an in-vehicle entertainment system according to an exemplary embodiment;

FIG. 2 is an overhead view of a vehicle including the in-vehicle entertainment system of FIG. 1;

FIG. 3 is a pictoral diagram illustrating several possible components of the in-vehicle entertainment system of FIG. 1;

FIG. 4 is a perspective view of an in-vehicle entertainment system control panel according to an exemplary embodiment;

FIG. 5 is a schematic diagram of an in-vehicle entertainment system according to an exemplary embodiment; and

FIG. 6 is a schematic diagram of an integrated intercom and in-vehicle entertainment system according to an exemplary embodiment.

### DETAILED DESCRIPTION OF EXEMPLARY EMBODIMENTS

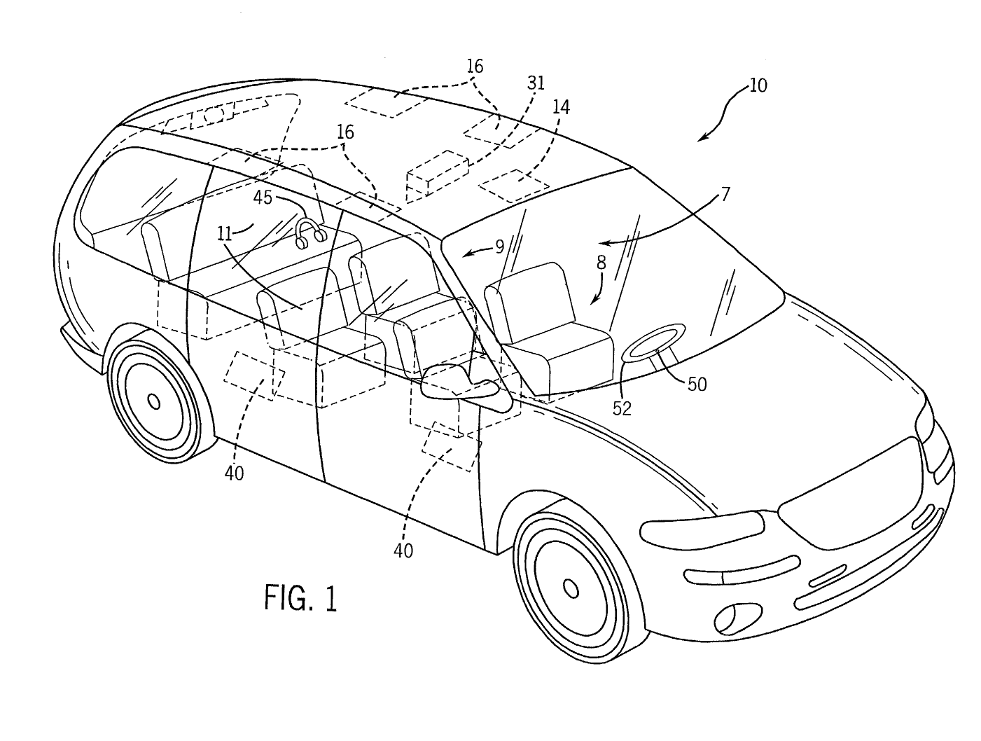

FIG. 1 is a cutaway perspective view of a vehicle including an in-vehicle entertainment system according to an exemplary embodiment. A vehicle or automobile 10 includes a passenger compartment 7 divided into a forward or front passenger compartment 8 and a rear passenger compartment 9. Vehicle 10 may be a car, truck, or other vehicle. The exemplary embodiment of FIG. 1 illustrates vehicle 10 in the form of a van. A driver of vehicle 10 sits in forward compartment 8 to control vehicle 10. A passenger may also sit in forward compartment 8 in a seat next to the driver. Rear compartment 9 may include benches or seats 11 for use by a plurality of passengers. In larger vehicles such as vans and sport utility vehicles, two or more rows of seats may be included in rear compartment 9. Overhead lights 1 6 may also be provided to illuminate passenger compartment 7.

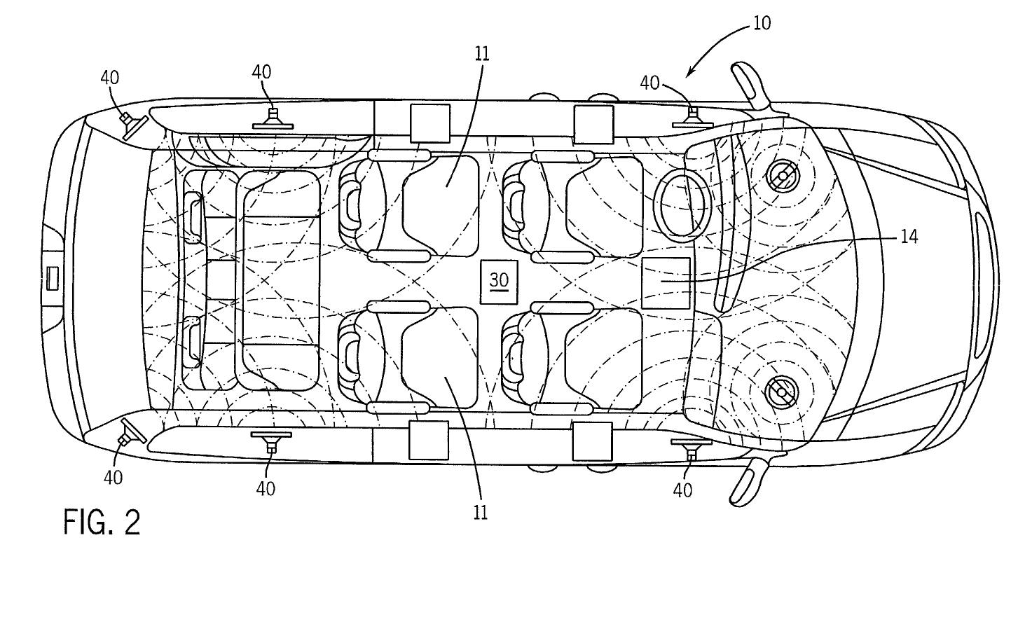

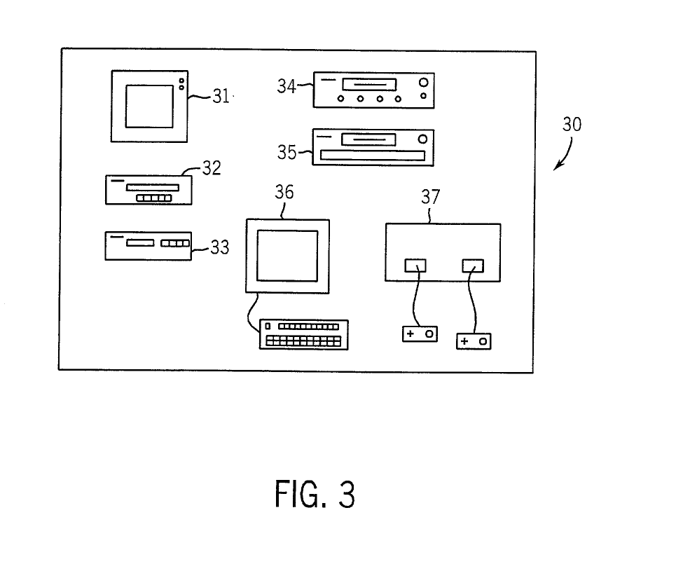

Vehicle 10 may also include an in-vehicle entertainment system 30 configured for providing entertainment to passengers in vehicle 10, as shown in FIG. 2. Entertainment system 30 may include one or more electronic components, as illustrated in FIG. 3. These components may include a television 31, video cassette player 32, digital versatile disc (DVD) player 33, stereo system 34, compact disc (CD) player 35, computer 36, video game console 37, and any other entertainment component that may be adapted for use with in-vehicle entertainment systems. For example, laser disc players and LCD display monitors may be included in the entertainment system. Additionally, the various components may operate simultaneously to allow different passengers to enjoy different entertainment options at the same time.

Entertainment system 30 may be located in any suitable position in vehicle 10, or may be distributed throughout vehicle 10. For example, television 31 may be mounted to an interior roof or headliner of passenger compartment 7, while video cassette player 32 may be located in forward passenger compartment 8 or in rear passenger compartment 9. Additionally, more than one of each type of component may be included in entertainment system 30. For example, both the forward and rear passenger compartments may have separate stereo systems, so as to allow passengers in the forward compartment 8 to listen to different audio broadcasts than those passengers in rear compartment 9.

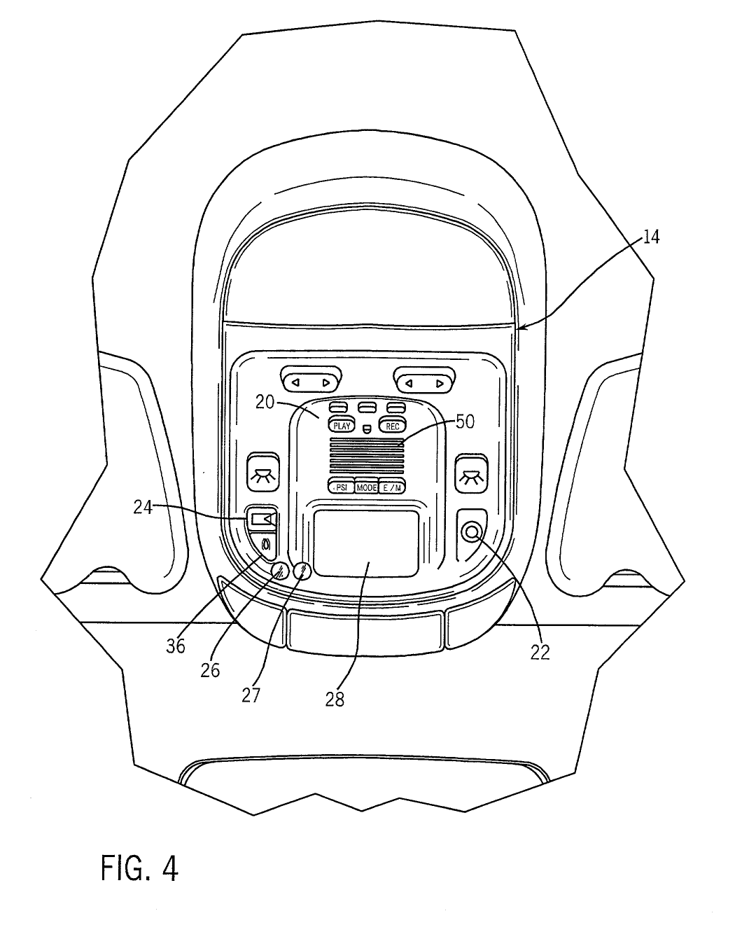

Entertainment system 30 may be operated using a number of different interfaces. FIG. 4 is a diagrammatic view of an in-vehicle entertainment system control panel according to an exemplary embodiment. Control panel 14 is mounted on the interior roof or headliner of vehicle 10 (illustrated in FIG. 1), and includes entertainment control buttons or switches 20 for operating components of entertainment system 30. Control switches 20 may be configured to activate any of a number of functions, such as playing, rewinding, fast forwarding, stopping, and pausing a video or audio source. Additionally, switches may be provided for adjusting the volume and changing a channel, or any other appropriate function for use with entertainment system 30. Control panel 14 may also include a display 28 for displaying information for the user of control panel 14, a camera 22 and associated power switch 24 for viewing the contents of passenger compartment 7, light adjustment knobs or switches 26 and 27, and input selection button 36. Any type of control switches or knobs that may be configured for controlling entertainment system 30 or other features of vehicle 10 may be included in control panel 14, and the type and configurations of switches and knobs may be modified depending on design or functional considerations. For example, control panel 14 may be mounted elsewhere in the vehicle, such as in the rear passenger compartment 9. Multiple control panels 14 may also be provided in vehicle 10, and may include either identical or differing configurations. For example, a control panel 14 in a front passenger compartment 8 may include only basic controls such as volume control and the like, while a control panel 14 in a rear passenger compartment may include many switches and knobs configured for controlling a plurality of entertainment system components.

To enhance the listening experience for the various entertainment system components, at least one loudspeaker or speaker 40 may be mounted within passenger compartment 7. As illustrated in FIGS. 1 and 2, a plurality of loudspeakers 40 may be distributed throughout passenger compartment 7. In an exemplary embodiment, all speakers 40 broadcast identical audio signals. In an alternative embodiment, speakers 40 located in forward compartment 8 may be configured to broadcast different audio signals than speakers 40 located in rear compartment 9. Thus, a driver and another passenger in forward compartment 9 may listen to music while passengers in rear compartment 9 listen to film audio. Additionally, speakers 40 may be controlled individually or in groupings. Thus, the speaker volume may be adjusted to balance sound between the right and left sides of vehicle 10 and between the front and back of vehicle 10. The volume may also be adjusted on a speaker-by-speaker basis to provide optimal audio output in a given situation.

Vehicle 10 may also be equipped with at least one pair of headphones 45 configured for receiving audio signals broadcast from entertainment system 30. Headphones 45 may be either wireless or wired headphones, and may have any of a number of configurations. For example, headphones 45 may include two speaker pads designed to fit over the ears of an individual. Alternatively, headphones 45 may include one or more smaller speakers configured to fit snugly inside an individual's ear. For traditional wired headphones 45, output jacks or connectors may be located at various locations in vehicle 7 to allow passengers to conveniently connect headphones 45 to entertainment system 30.

One advantageous feature of including headphones in entertainment system 30 is that passengers may listen to audio broadcasts without disturbing other passengers. Thus, one passenger may listen to a music CD while other passengers enjoy a silent ride or listen to a different audio broadcast over speakers 40. Alternatively, multiple pairs of headphones 45 may be provided to allow passengers to listen to different audio broadcasts. In this alternative embodiment, two passengers may each use a pair of headphones: one may listen to a music CD while another may listen to audio from a film broadcast from video cassette player 32 or DVD player 33. Other passengers may then listen to another audio source over speakers 40 if so desired.

In an exemplary embodiment, vehicle 10 also includes at least one microphone 50 in communication with speaker 40 to form an intercom system. Multiple microphones 50 may also be included in vehicle 10 for use by a number of different passengers, and may be located in any convenient location within passenger compartment 7. In an exemplary embodiment, microphone 50 is integrated into the driver console (e.g., steering wheel, dashboard, instrumental panel, etc.) or headliner to allow hands-free operation by the driver of vehicle 10. FIG. 1 illustrates one such embodiment, in which microphone 50 is included in a steering wheel 52. In an alternative embodiment illustrated in FIG. 4, microphone 50 is included in entertainment system control panel 14 in a headliner. In other alternative embodiments, microphone 50 may be located elsewhere in vehicle 10, in a headset worn by the driver or other passenger, or may be a handheld microphone.

Additionally, microphone 50 may include either a wired or wireless connection with speaker 40. For example, in an embodiment in which microphone 50 is located in a headset, an antenna or other similar transmitter may be included in the headset for broadcasting sounds from microphone 50 to speaker 40 using radio frequency (RF), microwave, infrared, or other types of signals used in wireless communication technology. Wired versions of microphone 50 are typically integrated in the vehicle, such as in a steering wheel or entertainment system control panel 14, and include wires for transmitting sounds to speakers 40.

The operation of a vehicle communication system will now be described with reference to FIGS. 1-4. As described above, one or more passengers in passenger compartment 7 may wear headphones 45 to listen to audio signals output from entertainment system 30. In certain situations, the volume level of the audio signals output from entertainment system 30 to headphones 45 may be such that the headphone-wearing passenger is unable to hear normal spoken voices of others in vehicle 10. A driver or passenger desiring to speak with the headphone-wearing passenger may therefore find it desirable to override or interrupt the audio signal input to headphones 45 from entertainment system 30.

In an exemplary embodiment, a driver or other passenger activates microphone 50 to deliver a message or other audio signal to at least one speaker 40. Microphone 50 may be activated by manually activating a microphone switch, such as by depressing a button or toggling a switch configured for turning on the microphone. Alternatively, microphone 50 may be voice-activated, such that a passenger may activate microphone 50 simply by speaking or otherwise inputting sound into microphone 50.

Activating microphone 50 operates to automatically interrupt or override a broadcast from entertainment system 30. In an exemplary embodiment, audio output to headphones 45 from entertainment system 30 may be muted either at entertainment system 30 or at headphones 45 such that no sound is heard through headphones 45. In another exemplary embodiment, headphones 45 may be entirely disabled upon activation of microphone 50. It should also be noted that the interruption of audio signals transmitted to headphones 45 need not entirely eliminate sound heard through headphones 45. For example, in another exemplary embodiment, interrupting the audio signal may involve decreasing the sound volume of the audio, either at entertainment system 30 or at headphones 45. By decreasing the sound volume, passengers wearing headphones 45 may be able to hear sounds external to headphones 45.

To minimize inconvenience to passengers wearing headphones 45, activating microphone 50 may concurrently suspend the performance of components in entertainment system 30. In an exemplary embodiment, activating microphone 45 not only interrupts sound broadcast to headphones 45, but also suspends or pauses the entertainment component associated with the broadcast audio. For example, in the case of a passenger listening to a music CD, activating microphone 50 may interrupt the broadcast to headphones 45 and also pause or stop the operation of CD player 35. Similarly, in the case of a passenger viewing a film or other video broadcast, activating microphone 50 may interrupt the sound and pause or stop operation of the associated video component (e.g., DVD player 33, video cassette player 32, etc.). One advantageous feature of suspending action by the entertainment system component is that the passenger using that component need not manually adjust the entertainment system component to return to the point of interruption (i.e., rewind the video tape, etc.) following the deactivation of microphone 50. Instead, deactivating the microphone may cause the entertainment component to continue from the point of interruption, such that the passenger does not miss portions of the broadcast.

Concurrently with the interruption of the entertainment system broadcast, in an exemplary embodiment, a message or other sound is transmitted from microphone 50 to at least one speaker 40. The message or sound is broadcast from speaker 40 with sufficient volume to be audible even to passengers wearing headphones. This advantageously allows a driver or other passenger to deliver a message or sound to all passengers, regardless of whether they are wearing headphones 45 or using components of entertainment system 30. Further, the amplification of sound broadcast from speaker 40 allows a driver or other passenger to communicate with passengers in vehicle 10 despite extraneous noises in passenger compartment 7 which may otherwise prevent audible communication.

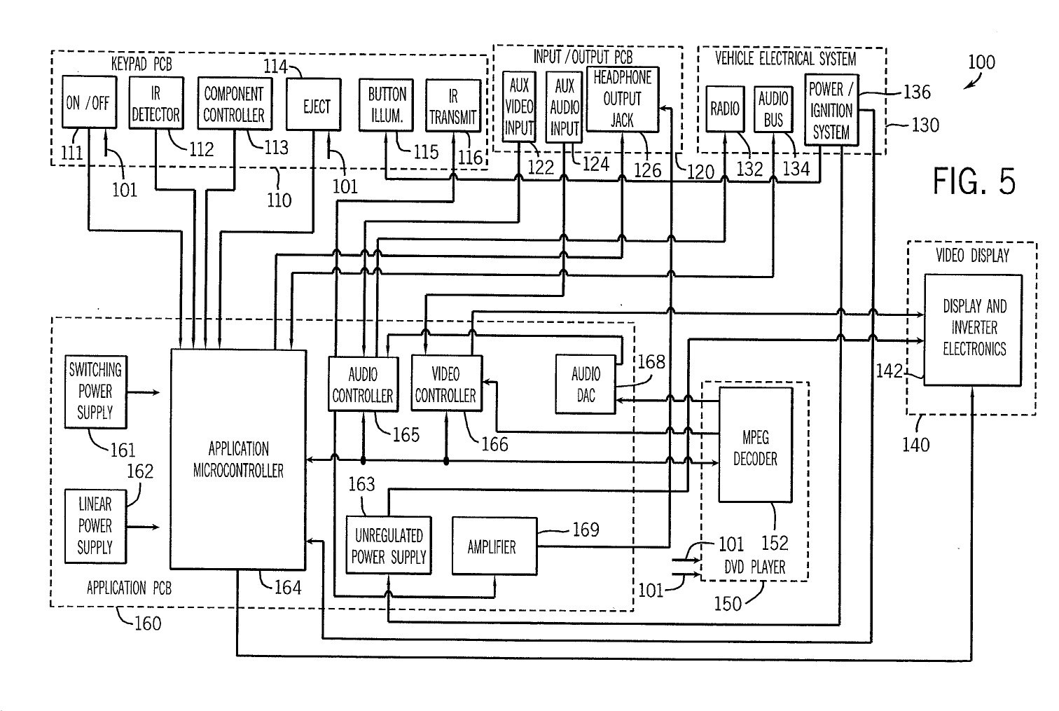

FIG. 5 is a schematic diagram of an in-vehicle entertainment system according to an exemplary embodiment. A keypad printed circuit board (PCB) 110 may provide an interface to allow users of an entertainment system 100 to control various components in entertainment system 100. For example, keypad PCB 110 may include an on/off switch 111, a component controller 113 for issuing various commands related to operation of a DVD player or other entertainment system component (e.g., volume adjustment, play, rewind, etc.), and an eject switch 114 for ejecting DVDs from the DVD player (or other media from another entertainment system component). Other items may be included in keypad PCB 110, such as an infrared (IR) detector 112 for detecting signals from an infrared input device such as a remote control, an IR transmitter 116 for sending infrared audio signals to wireless headphones worn by passengers in a vehicle, and a button illumination control 115 for adjusting the backlighting for keypad buttons 111-116.

An input/output PCB 120 may be provided for receiving audio and video signals from various entertainment system components and for transmitting audio signals to wired headphones. Auxiliary audio input jack 122 and auxiliary video input jack 124 may receive signals for use in entertainment system 100. For example, one or more cables may be used to connect a videocassette player and video input jacks 122, 124. Headphone output jacks 126 may receive audio signals from an entertainment system component such as a CD player and transmit the signals through a wired connection to at least one pair of headphones.

In an exemplary embodiment, in-vehicle entertainment system 100 may include a DVD player 150 and a video display 140 (e.g., a television, LCD display, or monitor). DVD player 150 may include an MPEG decoder 152, and video display 140 may include a variety of display and inverter electronics 142. A radio 132 may also be included in vehicle electrical system 130, along with an audio bus 134. In alternative embodiments, other entertainment system components may also be included in entertainment system 100, such as a videocassette player, CD player, cassette player, or computer.

Power is provided to the various components of entertainment system 100 by a power and ignition system 136 included in vehicle electrical system 130. Discrete power inputs 101 may provide power to DVD player 150 or other components of entertainment system 100. A switching power supply 161 and linear power supply 162 may also be provided. Discrete power inputs 101, switching power supply 161, and linear power supply 162 may in turn receive power from a battery located in a vehicle, for example, a 12 volt or 42 volt battery.

Entertainment system 100 may include an application PCB 160 for controlling various entertainment system components and receiving inputs from a user of entertainment system 100. An application microcontroller 164 may provide instructions to various components of entertainment system 100. Application PCB 160 may also include an unregulated power supply 163 that receives power from power and ignition system 136 and an audio digital-to-analog converter 168 converting digital signals received from an entertainment system component to analog signals for use in entertainment system 100. An amplifier 169 may increase the sound intensity of signals transmitted to headphones worn by users of entertainment system 100. An audio controller 165 and video controller 166 may receive audio and video signal inputs, respectively, from an entertainment system component. Audio and video controllers 165, 166 may then either transmit or interrupt the audio or video signals. In one embodiment, interruption of audio signals by audio controller 165 may be accomplished by muting or decreasing the volume of the audio signals.

In operation, microcontroller 164 receives an instruction from a user of keypad 110. For example, a user may activate a DVD player by pressing a “Play” button on component controller 113. Microcontroller 164 may then issue a command to a component in entertainment system 100, such as an instruction to DVD player 150 to play a DVD. Microcontroller 164 may provide any of a variety of operating instructions to video display 140, headphone output jacks 126, audio bus 134, audio controller 166, and video controller 168.

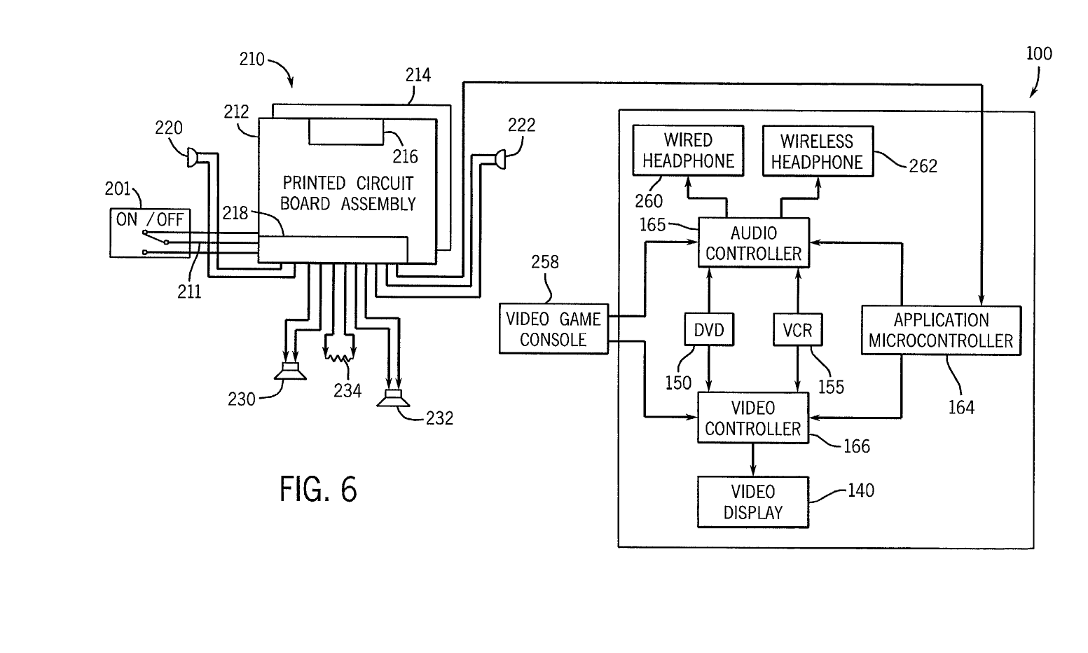

FIG. 6 is a schematic diagram of an integrated intercom and in-vehicle entertainment system according to an exemplary embodiment. Intercom system 210 includes a printed circuit board (PCB) assembly 212 contained within a container or housing 214. Power is provided to intercom system 210 through a vehicle connector 216, which couples intercom system 210 to a vehicle electrical system. An interface connector 218 may be provided to couple intercom system 210 to a variety of intercom components, such as a volume control 234, driver side microphone 220, and passenger side microphone 222. Interface connector 218 further couples intercom system 210 to at least one loudspeaker. As illustrated in FIG. 6, intercom system 210 is connected to two loudspeakers 230, 232. The placement of various intercom system 210 components may vary in particular applications. For example, larger vehicles such as vans may include more than one row of seats in the rear passenger compartment. One or more loudspeakers may be provided for each row of seats, to provide optimal sound distribution in the passenger compartment. Additionally, any number and configuration (e.g., placement) of microphones or loudspeakers may be used. Each passenger seat location may be equipped with a separate microphone, for instance.

Application microcontroller 164 is connected to audio controller 165. Audio controller 165 may operate to control audio signals input to entertainment system 100 from one or more entertainment components. As illustrated, both a DVD player 150, video cassette player 155, and video game console or system 258 are coupled to audio controller 165. Other configurations are possible. For example, a CD player or cassette player may provide audio signal input. Audio controller 165 may also control sound output to one or more pairs of headphones. As shown, audio controller 165 is coupled to one pair of wired headphones 260 and one pair of wireless headphones 262. In alternative embodiments, a different number of headphones may be connected to audio controller 165. For example, two or more pairs of wired headphones may be connected to audio controller 165.

Application microcontroller 164 is also connected to video controller 166. Video controller 166 may operate to control video signals input to entertainment system 100 from one or more entertainment components. Similarly to audio controller 165, video controller 166 is configured to receive inputs from DVD player 150, videocassette player 155, and video game console 258. Video controller 166 is connected to video display 140, which may be a television, liquid crystal display (LCD), or any other display. Other entertainment system components having video outputs may be included in entertainment system 100. Further, multiple displays may be used throughout the vehicle and receive inputs from video controller 166.

In operation, a user of intercom system 210, such as a driver or passenger, may toggle or otherwise operate an on/off switch 201 to activate intercom system 210. Intercom system 210 is coupled to application microcontroller 164 in entertainment system 100 by a circuit or switch status line 211. Upon activation of switch 201, switch status line 211 provides an indication to application microcontroller 164 that intercom system 210 has been activated. Application microcontroller 164 then issues an instruction to audio controller 165 to interrupt the broadcast of audio signals from an entertainment system component (e.g., DVD player 150, video game console 258, etc.) to headphones 260, 262, such as by muting the audio signals or by decreasing the volume of the audio signals. Activating switch 201 may also act to interrupt video signals from entertainment system components to video display 140. For example, activating switch 201 may interrupt video signals from DVD player 150 to video display 140. In another embodiment, video signals from video game console 258 may be interrupted. After activating switch 201 and interruption of audio and/or video signals from entertainment system components to headphones 260, 262 and video display 140, the driver or passenger may then speak into one of the intercom system microphones 220, 222, and the message may be broadcast over one or more of the intercom system loudspeakers 230, 232. If desired, the volume of sound broadcast over loudspeakers 230, 232 may be controlled by adjusting volume control 234. In an exemplary embodiment, loudspeakers 230, 232 may be connected both to intercom system 210 and to in-vehicle entertainment system 100. In this embodiment, audio signals from one entertainment system component may be broadcast to a pair of headphones while a separate audio signal from a different component may be broadcast over one or more loudspeakers 230, 232.

It should also be noted that in an exemplary embodiment, interruption of audio and/or video signals may be accompanied by the pausing or suspension of active entertainment system components, so as to allow the entertainment system component to continue from the point of interruption when switch 201 is toggled or otherwise switched off. For example, upon activating switch 201, videocassette player 155 may be paused or stopped at the point of interruption. In another embodiment, video game console 258 may be paused or stopped. De-activating switch 201 may cause the paused or stopped entertainment component to begin operation again at the point of interruption.

While the detailed drawings and specific examples describe exemplary embodiments, they serve the purpose of illustration only. The inventions disclosed are not limited to the specific forms shown. For example, the methods may be performed in any of a variety of sequence of steps. The hardware configurations may also differ, depending on the number and type of features included in a particular intercom or in-vehicle entertainment system. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A method of communicating with passengers in an automobile, the method comprising:
activating a microphone;
interrupting a broadcast by an in-vehicle entertainment system, the broadcast comprising audio signals, the audio signals being transmitted to headphones worn by at least one passenger; and
broadcasting sound from the microphone to at least one loudspeaker.

2. The method of claim 1, wherein activating the microphone comprises receiving an input from a manually activated microphone switch.

3. The method of claim 1, wherein activating the microphone consists of receiving voice signals at the microphone.

4. The method of claim 1, wherein activating the microphone causes the interruption of the broadcast.

5. The method of claim 1, wherein interrupting the broadcast comprises reducing the sound volume of the audio signals.

6. The method of claim 1, wherein interrupting the broadcast comprises muting the audio signals.

7. The method of claim 1, wherein interrupting the broadcast comprises disabling the headphones.

8. The method of claim 1, wherein the broadcast further comprises video signals.

9. The method of claim 8, wherein interrupting the broadcast comprises muting the audio signals and simultaneously suspending the video signals.

10. The method of claim 1, further comprising deactivating the microphone and resuming the broadcast from the point of interruption.

11. The method of claim 1, wherein the in-vehicle entertainment system comprises at least one device selected from a television, video cassette player, DVD player, video game console, stereo receiver, compact disc player, and computer.

12. The method of claim 1, wherein the audio signals are transmitted to the headphones using a wireless connection.

13. A method of enabling communication between vehicle passengers, the method comprising:
activating an intercom system, the intercom system including a microphone and at least one speaker configured for broadcasting sound from the microphone;
interrupting audio signals being broadcast from a vehicle entertainment system to at least one pair of headphones; and
transmitting a message from the microphone to the at least one speaker.

14. The method of claim 13, wherein activating the intercom system comprises receiving an input from a manually activated microphone switch.

15. The method of claim 13, wherein activating the intercom system consists of receiving voice signals at the microphone.

16. The method of claim 13, further comprising muting audio signals being broadcast from the vehicle entertainment system to all speakers in the vehicle.

17. The method of claim 13, wherein the headphones are in wireless communication with the entertainment system.

18. The method of claim 13, wherein the entertainment system comprises at least one device selected from a television, a video cassette player, a DVD player, a video game console, a stereo receiver, a compact disc player, and a computer.

19. The method of claim 13, further comprising interrupting video signals being broadcast from the vehicle entertainment system.

20. A system for enhancing communication with vehicle passengers, the system comprising:
a microphone located in a forward section of a vehicle;
at least one loudspeaker in communication with the microphone;
at least one pair of headphones in communication with an in-vehicle entertainment system, the headphones configured for receiving audio signals broadcast from the entertainment system; and
means for overriding audio signals transmitted from the entertainment system to the headphones and simultaneously broadcasting audio signals from the microphone to the loudspeaker.

21. The system of claim 20, wherein the microphone includes wireless communication means.

22. The system of claim 20, wherein the microphone is an integrated component of a driver console.

23. The system of claim 20, wherein the microphone is voice activated.

24. The system of claim 20, wherein the headphones are in wireless communication with the entertainment system.

25. The system of claim 20, wherein overriding audio signals comprises muting the audio signals.

26. The system of claim 20, wherein overriding audio signals comprises decreasing the volume of the audio signals.

27. The system of claim 20, wherein overriding audio signals comprises disabling the headphones.

28. The system of claim 20, wherein the entertainment system comprises at least one device selected from a television, a video cassette player, a DVD player, a video game console, a stereo receiver, a compact disc player, and a computer.

29. The system of claim 20, further comprising means for interrupting video signals from the entertainment system.

30. A communications system for use in conjunction with in-vehicle entertainment components, the system comprising:
an in-vehicle entertainment system, the entertainment system including at least one loudspeaker, at least one electronic component capable of generating audio signals, and at least one pair of headphones configured for receiving the audio signals; and
a control circuit configured for interrupting the audio signals and broadcasting a message to the at least one loudspeaker.

31. The system of claim 30, wherein the electronic component comprises at least one of a television, video cassette player, DVD player, video game console, stereo receiver, compact disc player, and computer

32. The system of claim 30, further comprising a microphone.

33. The system of claim 32, wherein the microphone includes wireless communication means.

34. The system of claim 32, wherein the microphone is an integrated component of a driver console.

35. The system of claim 32, wherein the microphone is voice activated.

36. The system of claim 32, wherein interrupting audio signals comprises muting the audio signals.

37. The system of claim 32, wherein interrupting the audio signals comprises decreasing the volume of the audio signals.

38. The system of claim 30, wherein the headphones are in wireless communication with the entertainment system.

39. The system of claim 30, further comprising means for interrupting video signals from the entertainment system.
